(19) United States
(12) Patent Application Publication
(10) Pub. No.: US 2022/0138823 A1
(43) Pub. Date: May 5, 2022

(54) INFORMATION PROCESSING APPARATUS, INFORMATION PROCESSING METHOD, AND STORAGE MEDIUM

(71) Applicant: TOYOTA JIDOSHA KABUSHIKI KAISHA, Toyota-shi (JP)

(72) Inventors: Akira SASAKI, Miyoshi-shi (JP); Osamu IZUMIDA, Nagoya-shi (JP); Satoshi KOMAMINE, Nagoya-shi (JP); Koshi ITO, Okazaki-shi (JP); Ayana TAKESHITA, Kasugai-shi (JP); Daisuke MURAKAMI, Okazaki-shi (JP)

(73) Assignee: TOYOTA JIDOSHA KABUSHIKI KAISHA, Toyota-shi (JP)

(21) Appl. No.: 17/512,069

(22) Filed: Oct. 27, 2021

(30) Foreign Application Priority Data
Nov. 2, 2020 (JP) 2020-183528

(51) Int. Cl. G06Q 30/06; G06Q 40/02; G06Q 20/12; G06Q 20/08; G06Q 30/02; G06Q 10/08

(52) U.S. Cl. CPC G06Q 30/0617; G06Q 30/0631; G06Q 40/02; G06Q 10/087; G06Q 20/0855; G06Q 30/0201; G06Q 20/12

(57) ABSTRACT

An information processing apparatus comprises a controller configured to acquire a purchase history of products purchased by a user in a past, make a determination, based on the purchase history, that there is a target product that is purchased by the user on a regular basis, and make a proposal to the user, based on a result of the determination, to purchase the target product using a periodic purchase service.

### CROSS REFERENCE TO THE RELATED APPLICATION

This application claims the benefit of Japanese Patent Application No. 2020-183528, filed on Nov. 2, 2020, which is hereby incorporated by reference herein in its entirety.

### BACKGROUND

### Technical Field

The present disclosure relates to a technology for aiding a user.

### Description of the Related Art

There are technologies for supporting purchase of products that are consumed on a regular basis, such as household supplies.

For example, Japanese Patent Laid-Open No 2003-150868 discloses a system for issuing, via a network, a request to purchase a product on a regular basis (periodic purchase).

### SUMMARY

It is not easy for a general consumer to appropriately determine whether it is better to periodically purchase a product that is used on a daily basis, and periodic purchase is thus prevented from being widely used.

The present disclosure is aimed at reducing a burden, on a user, related to purchase of a product.

The present disclosure in its one aspect provides an information processing apparatus comprising a controller configured to acquire a purchase history of products purchased by a user in a past, make a determination, based on the purchase history, that there is a target product that is purchased by the user on a regular basis, and make a proposal to the user, based on a result of the determination, to purchase the target product using a periodic purchase service.

The present disclosure in its another aspect provides an information processing method comprising: acquiring a purchase history of products purchased by a user in a past; making a determination, based on the purchase history, that there is a target product that is purchased by the user on a regular basis; and making a proposal to the user, based on a result of the determination, to purchase the target product using a periodic purchase service.

Furthermore, as other modes, a program for performing the information processing method described above, or a non-transitory computer-readable storage medium storing the program may be cited.

According to the present disclosure, a burden, on a user, related to purchase of a product may be reduced.

### BRIEF DESCRIPTION OF THE DRAWINGS

FIG. 1 is a diagram for describing an outline of an information processing system;

FIG. 2 is a diagram illustrating in detail structural elements of an information processing system according to a first embodiment;

FIG. 3 is a diagram for describing user data that is stored in a storage;

FIG. 4 is a diagram illustrating a flow of data between apparatuses;

FIG. 5 is an example of purchase history data that is provided by an EC server;

FIG. 6 is a flowchart of a process that is performed by a controller in the first embodiment;

FIG. 7 is an example of purchase history data according to a second embodiment; and

FIG. 8 is a flowchart of a process that is performed by a controller in the second embodiment.

### DESCRIPTION OF THE EMBODIMENTS

There is known a service for delivering a predetermined product such as a household supply or an alcoholic beverage on a regular basis upon request by a user (a periodic purchase service). However, such a service requires a delivery interval and an order quantity to be appropriately set, and such a requirement prevents the service from being used. Moreover, it is not easy for a consumer to determine whether to apply for periodic purchase or not.

To cope with such a situation, an information processing apparatus according to a mode makes a proposal to a user to use a periodic purchase service, based on a purchase history of products purchased by the user.

The periodic purchase service in the present specification refers to a service of delivering a target product on a regular basis, at a predetermined interval desired by a user, and “to periodically purchase” refers to purchasing a product through the service. Such a mode is referred to also as “subscription”. A periodic purchase service includes a mode of paying for a product every time the product is delivered, and a mode of making a payment for a certain period of time and receiving a specified number of products, for example.

The information processing apparatus includes a controller configured to acquire a purchase history of products purchased by a user in a past, make a determination, based on the purchase history, that there is a target product that is purchased by the user on a regular basis, and make a proposal to the user, based on a result of the determination, to purchase the target product using a periodic purchase service.

The target product is a product that is purchased by a user on a regular basis. The target product may be a household supply such as toilet paper, a discretionary item such as an alcoholic beverage, or a food item, for example. The controller determines that there is a target product that is purchased by the user on a regular basis, by referring to the purchase history of products purchased by the user. The purchase history of products may be acquired from a computer that is used by the user, or from an electronic commerce (EC) server.

In the case where there is a product that is purchased by the user on a regular basis, it is sometimes advantageous to use a periodic purchase service. Accordingly, the information processing apparatus determines, based on the purchase history of the user, whether it is better to use the periodic purchase service in relation to the target product, and autonomously makes a proposal to the user to use the periodic purchase service. Convenience of the user may thus be increased.

Furthermore, the controller may make the proposal in a case where the target product is purchased a predetermined number of times or more by the user in a predetermined period of time in the past.

The predetermined number of times desirably takes a value according to which a purchase may be evaluated to be performed on a regular basis.

Furthermore, the controller may acquire a reply of the user to the proposal, and may transmit, based on the reply, data for applying for use of the periodic purchase service, to a server apparatus that provides the periodic purchase service.

For example, an application for use of the periodic purchase service may be submitted in a case where the user agrees with the proposal.

Furthermore, the controller may inquire of a server apparatus that provides the periodic purchase service whether the target product is handled or not, and may make the proposal in a case where the target product is handled by the periodic purchase service.

According to such a configuration, the proposal may be made only when the periodic purchase service can be used in relation to the target product.

Furthermore, the controller may determine a purchase interval of the target product in a predetermined period of time in the past, based on the purchase history, and may propose a delivery interval for the periodic purchase service, based on the purchase interval.

This is because a delivery interval for periodic purchase of a product is desirably the same as an interval at which the product is purchased by the user himself/herself.

Furthermore, the controller may make the proposal in a case where dispersion in the purchase interval is smaller than a predetermined value.

This is because, if the purchase intervals are varied, even if a target product is purchased several times, it can be evaluated that the user is not purchasing the product on a regular basis. The dispersion may be determined through variance or standard deviation, for example.

Furthermore, the target product may include a plurality of variations of products that are different from each other only in terms of net quantity.

This is because a plurality of packages may include same contents in different net quantities, and if these packages are treated as different products, it cannot be correctly determined that the user is purchasing the same product on a regular basis.

Furthermore, the controller may acquire a purchase interval of the target product in a predetermined period of time in the past and information indicating the net quantity of a package of the target product, and may estimate a pace of consumption of the target product.

Furthermore, the controller may make a proposal regarding a delivery interval and an order quantity for the periodic purchase service, based on the pace of consumption that is estimated.

In the case where there is a plurality of packages with different net quantities, the pace of consumption of the target product by the user may be estimated. This enables determination to be accurately made as to which package is to be made a target of periodic purchase (or in other words, about what quantity is to be ordered at one time) and the delivery interval.

Furthermore, the controller may estimate a stock quantity of the target product in possession of the user, based on the pace of consumption that is estimated, and may make the proposal at a timing when the stock quantity falls below a predetermined value.

According to such a configuration, the proposal for the periodic purchase service may be made at a timing when the stock quantity of the target product in possession of the user is reduced.

In the following, embodiments of the present disclosure will be described with reference to the drawings. Configurations of the embodiments below are merely examples, and the present disclosure is not limited to the configurations of the embodiments.

### First Embodiment

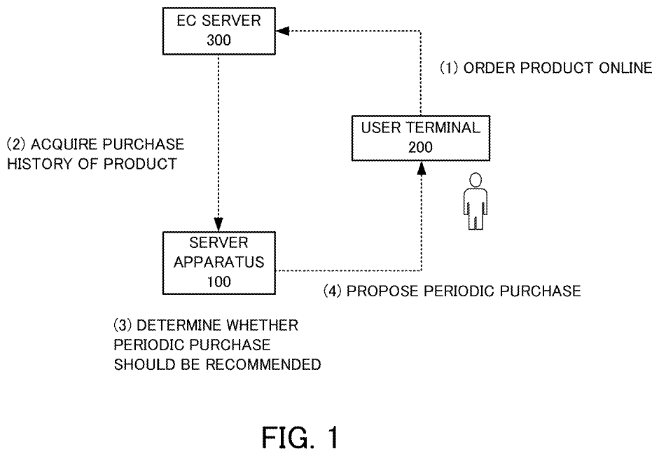

An outline of an information processing system according to a first embodiment will be described with reference to FIG. 1. The information processing system according to the present embodiment includes a user terminal 200 that is an apparatus that is used by a user to place an order for a product, an EC server 300 that receives an order for a product, and a server apparatus 100 that makes a proposal to use a periodic purchase service, based on a history of orders placed by the user.

The EC server 300 is an apparatus that receives an order for a product over a network (such as the Internet). The EC server 300 incorporates a web server, and the user is able to place an order for a product by logging into an EC site via a web browser. The EC server 300 is managed by an operator operating a mail order business.

The user terminal 200 is a computer owned by the user. The user may access the EC server 300 via the user terminal 200, and may place an order for (i.e., apply for purchase of) a product.

The server apparatus 100 determines whether periodic purchase should be used for a specific product, based on a purchase history associated with the user (a history of products ordered by the user via the EC site). Furthermore, in the case where it is determined that periodic purchase can be used, a proposal is made to the user. According to the proposal, the user may apply to the EC server 300 for periodic purchase of the corresponding product.

The server apparatus 100 may be installed at home of the user, or may be installed at a separate location. Furthermore, one server apparatus 100 may be in charge of a plurality of users.

Moreover, the present example illustrates a single EC server 300, but there may be a plurality of EC servers 300 that provide a plurality of different EC sites.

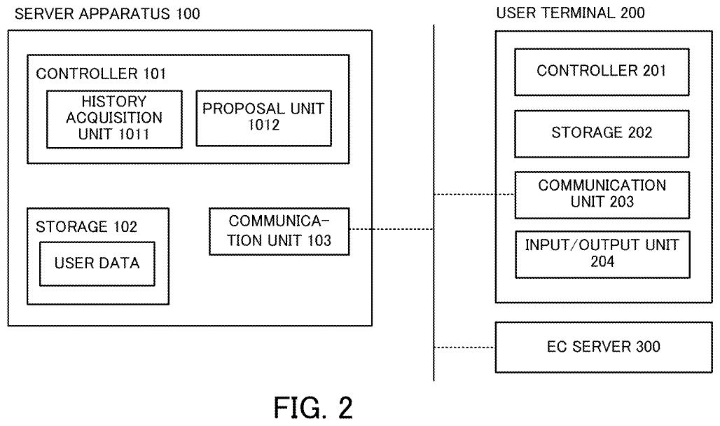

FIG. 2 is a diagram illustrating in greater detail structural elements of the information processing system according to the present embodiment. First, a description will be given of the user terminal 200.

For example, the user terminal 200 is a computer that is used by an individual, such as a personal computer, a smartphone, a mobile phone, a tablet computer, or a personal digital assistant. The user terminal 200 includes a controller 201, a storage 202, a communication unit 203, and an input/output unit 204.

The controller 201 is an arithmetic device that is in charge of control that is performed by the user terminal 200. The controller 201 may be implemented by an arithmetic processing device such as a central processing unit (CPU).

The controller 201 performs a function of accessing and interacting with the EC server 300. This function may be alternatively implemented by a web browser running on the user terminal 200.

The storage 202 includes a main memory and an auxiliary memory. The main memory is a memory where programs to be executed by the controller 201, and data to be used by the control programs are developed. The auxiliary memory is a device that stores the programs to be executed by the controller 201, and the data to be used by the control programs. The auxiliary memory may store the programs to be executed by the controller 201 in the form of packaged applications. An operating system for executing the applications may also be stored. Processes described later are performed by the programs stored in the auxiliary memory being loaded into the main memory and being executed by the controller 201.

The main memory may include a random access memory (RAM) and a read only memory (ROM). The auxiliary memory may include an erasable programmable ROM (EPROM) and a hard disk drive (HDD). The auxiliary memory may also include a removable medium, or in other words, a removable recording medium.

The communication unit 203 is a wireless communication interface for connecting the user terminal 200 to a network. For example, the communication unit 203 is capable of communicating with the server apparatus 100 and the EC server 300 by a wireless LAN or a mobile communication service such as 3G, LTE or 5G, for example.

The input/output unit 204 is a unit that receives an input operation performed by a user, and that presents information to the user, and is, in the present embodiment, one touch panel display, or in other words, a liquid crystal display and a control unit thereof, or a touch panel and a control unit thereof.

Next, a description will be given of the server apparatus 100.

The server apparatus 100 acquires a purchase history of products of a target user by logging into the EC server 300 using information that is set in advance, and moreover, determines whether periodic purchase of a product included in the purchase history is possible or not, and generates a proposal to the user based on the result of the determination.

The server apparatus 100 may be a general-purpose computer. That is, the server apparatus 100 may be a computer that includes processors such as a CPU, a GPU and the like, main memories such as a RAM, a ROM and the like, and auxiliary memories such as an EPROM, a hard disk drive, a removable medium and the like. The removable medium may be a USB memory, or a disk recording medium such as a CD or a DVD, for example. The auxiliary memory stores an operating system (OS), various programs, various tables and the like, and each function matching a predetermined object as described later may be implemented by controlling each structural unit or the like through execution of a program stored in the auxiliary memory, by loading the program into a work area of the main memory and executing the same. However, the functions may be partially or wholly implemented by a hardware circuit such as an ASIC or an FPGA.

The controller 101 is an arithmetic device that is in charge of control that is performed by the server apparatus 100. The controller 101 may be implemented by an arithmetic processing device such as a CPU.

The controller 101 includes two functional modules, that is, a history acquisition unit 1011 and a proposal unit 1012. Each functional module may be implemented by the CPU executing a program that is stored.

The history acquisition unit 1011 accesses the EC server 300, and acquires a purchase history of products of a target user for a predetermined period of time in the past (hereinafter referred to simply as “purchase history”). Information used to access the EC server 300 (such as authentication information for logging into the EC site) may be stored in the storage 102 described later. The history acquisition unit 1011 acquires the purchase history for a predetermined period of time in the past by logging into the EC site provided by the EC server 300, and transfers the acquired purchase history to the proposal unit 1012.

The proposal unit 1012 determines, based on the purchase history acquired from the EC server 300, whether to propose the user to use the periodic purchase service or not. Specifically, in the case where (1) a product is ordered a predetermined number of times (such as three times) or more in the predetermined period of time in the past and (2) an interval of the orders is evaluated to be a regular interval, and if (3) the periodic purchase service is applicable to the target product, a proposal to switch purchase of the product to periodic purchase is generated. The generated proposal is transmitted to the user terminal 200, and the periodic purchase service is applied for by an operation by the user.

The storage 102 includes a main memory and an auxiliary memory. The main memory is a memory where programs to be executed by the controller 101, and data to be used by the control programs are developed. The auxiliary memory is a device that stores the programs to be executed by the controller 101, and the data to be used by the control programs.

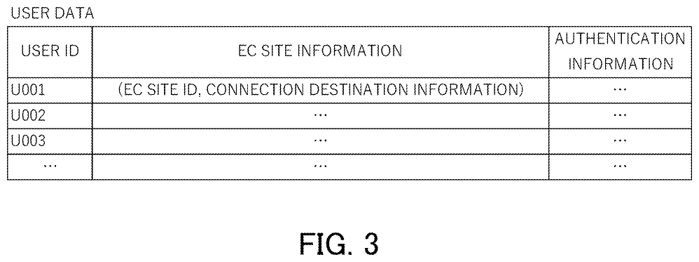

Furthermore, the storage 102 stores user data of a user. FIG. 3 is an example of the user data that is stored in the storage 102. The user data includes an identifier of a user, information (an identifier, an URL and the like) about an EC site that is used by the user, authentication information used to log into the EC site, and the like. In the case where the server apparatus 100 manages a plurality of users, the storage 102 may store the user data for a plurality of persons.

The communication unit 103 is a communication interface for connecting the server apparatus 100 to a network. For example, the communication unit 103 includes a network interface board, and a wireless communication interface for wireless communication.

The configurations illustrated in FIG. 2 are only examples, and the illustrated functions may be partially or wholly performed by a dedicated circuit. Furthermore, programs may be stored and executed by a combination of main memory and auxiliary memory other than those illustrated.

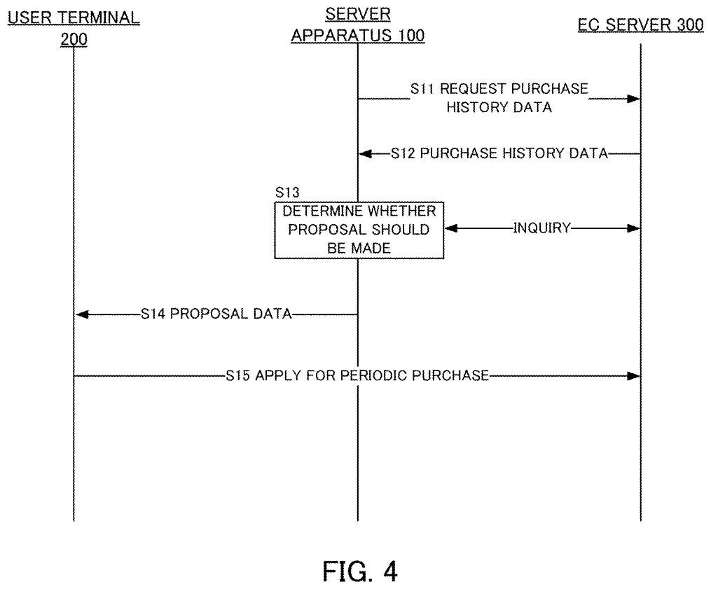

Next, processes to be performed by the server apparatus 100 will be described with reference to FIG. 4 that is a diagram illustrating data that is transmitted/received between apparatuses. The illustrated processes are performed on a per-user basis.

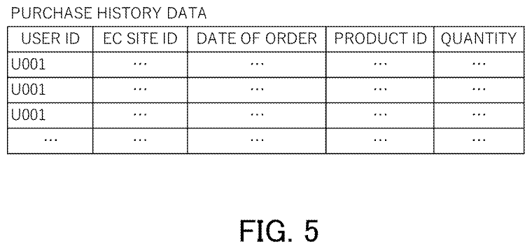

First, the history acquisition unit 1011 logs into the EC site provided by the EC server 300, every predetermined period of time, and requests purchase history data for a user (step S11). FIG. 5 is an example of the purchase history data. For example, the purchase history data includes the identifier of the user, the identifier of the EC site, a date of order of a product, an identifier of the product (such as a JAN code or an EAN code), and the number of products ordered. In response to the request, the EC server 300 transmits the purchase history data for the user to the server apparatus 100 (step S12).

In step S13, the proposal unit 1012 determines, based on the purchase history data that is acquired, whether to propose use of the periodic purchase service or not. In the present step, periodic purchase of a corresponding product is proposed in a case where the following conditions are satisfied.
(1) A specific product (hereinafter “target product”) is ordered a predetermined number of times or more in a predetermined period of time in the past.
(2) There is no dispersion in the order intervals for the target product.
(3) The target product is handled by the periodic purchase service.

A specific method will be described later.

In the case where the server apparatus 100 determines to propose use of the periodic purchase service, proposal data is transmitted to the user terminal 200 in step S14. The proposal data is data including a notice indicating that periodic purchase can be used for the target product, a recommended delivery interval, and a recommended order quantity, for example. The proposal data is presented to the user via the user terminal 200. When the user accepts the proposal, data for applying for periodic purchase is transmitted from the user terminal 200 to the EC server 300 (step S15).

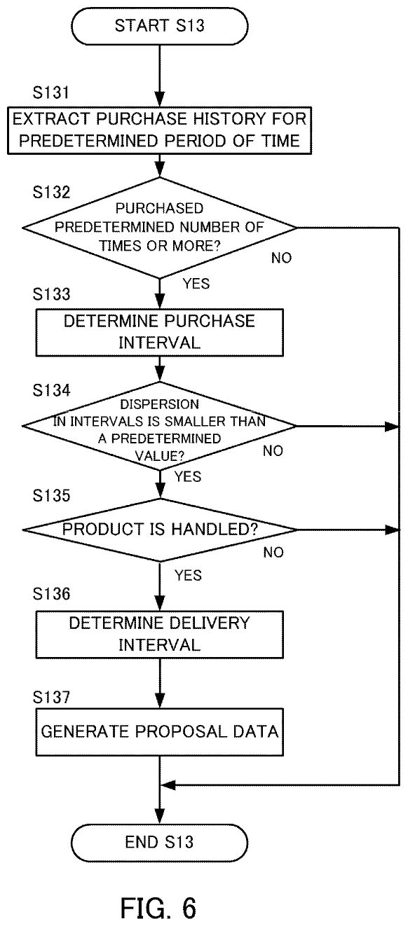

FIG. 6 is a flowchart for describing, in detail, a step performed by the server apparatus 100 to determine whether periodic purchase should be proposed or not (step S13).

First, in step S131, a purchase history of products for a predetermined period of time is extracted from the purchase history data. The predetermined period of time may be one month, three months, six months or the like, for example.

Next, in step S132, whether a specific product is purchased a predetermined number of times or more is determined. The predetermined number of times is desirably a number of times by which it can be determined that purchase is performed on a regular basis (for example, three or more times). In the case where a positive determination is made, the process proceeds to step S133.

In step S133, the purchase interval of the target product is determined. For example, in the case where a product is purchased four times in total, and order intervals are 24 days, 30 days, and 27 days, it can be seen that the product is purchased once in 27 days on average.

In step S134, whether dispersion in the determined purchase intervals is smaller than a predetermined value is determined. For example, in the case where the purchase intervals of a product fluctuate in the manner of 45 days, 30 days, and 10 days, it is assumed that one-time purchase is performed instead of purchase on a regular basis. Periodic purchase is not proposed in such a case. Dispersion may be determined by variance or standard deviation of purchase intervals (the number of days), for example.

Next, in step S135, whether the target product is handled by the periodic purchase service provided by the EC server 300 (whether periodic purchase is possible) is determined. In the present step, an inquiry is issued to the EC server 300 using the identifier of the product included in the purchase history, and a reply is acquired. In the case where periodic purchase is possible, the process proceeds to step S136. In the case where periodic purchase is not possible, the process is ended.

Additionally, in the present step, information necessary for the user to determine whether periodic purchase should be used or not (for example, details of the product, unit price of the product, a required number of days from application to delivery, and the like) may be acquired from the EC server 300.

In step S136, a delivery interval for the periodic purchase service is determined. The delivery interval for the periodic purchase service may be determined based on the purchase interval determined in step S133. For example, in the case where the target product is purchased several times in the past, an average value of the purchase intervals may be used.

In step S137, data for proposing periodic purchase of the product (the proposal data) is generated. The proposal data may include a notice recommending periodic purchase of the product, a recommended delivery interval, a recommended order quantity, amount of payment, unit price of the product, and the like.

Processes from step S14 are as described above.

As described above, with the system according to the first embodiment, a proposal to periodically purchase a product is made based on a history of purchase of the product performed, via the EC site, by the user in the past. According to such a configuration, purchase of a product that is consumed by the user on a regular basis may be switched to periodic purchase, and the burden on the user regarding purchase of the product may be reduced.

In the first embodiment, the proposal is generated in the case where the target product is handled by the periodic purchase service, but conditions may be further added. For example, the proposal may be made only in a case where the unit price of the product is cheaper than in the case of one-time purchase.

### Second Embodiment

In the first embodiment, a product with the same identifier as that of a product included in the purchase history is taken as the target of periodic purchase. However, same products may possibly come in a plurality of packages with different net quantities.

For example, in the case where packages with different net quantities are purchased by the user several times in the past, these are possibly not taken as the same product, and the proposal for periodic purchase is possibly not correctly made. Furthermore, even in a case where there is a package with more net quantity but with a lower product unit price than the one that is usually purchased by the user, such a package cannot be recommended to the user.

The second embodiment is for coping with such a situation, and is an embodiment where products of same contents are grouped, and a process is performed using the group. Furthermore, in the second embodiment, a pace of consumption of a product by a user is estimated, and a manner of periodic purchase matching the pace of consumption is proposed.

Accordingly, even if there is a plurality of packages with different net quantities in relation to a target product, a proposal may be correctly made.

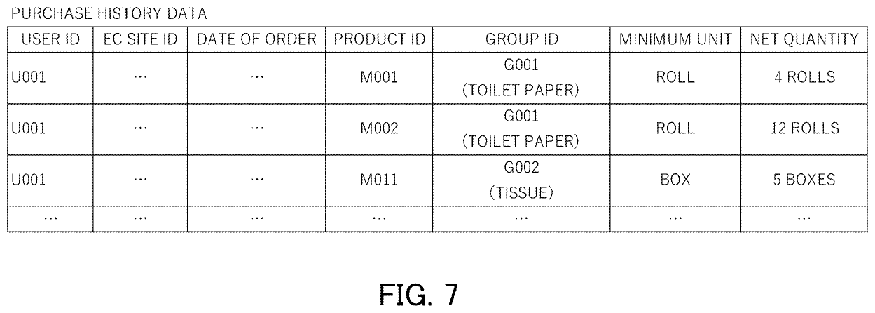

FIG. 7 is an example of purchase history data according to the second embodiment. As illustrated, in the present embodiment, a group ID is added in the purchase history data. The group ID is an identifier of a product group, and a same group ID is assigned to same products with different net quantities, numbers of contained pieces or the like. Accordingly, a different package having the same (substantially the same) contents and is different only in terms of net quantity may be specified.

Furthermore, in the second embodiment, a minimum unit of product and information about net quantity are added in the purchase history data. Accordingly, an approximate quantity of product that is purchased by the user may be determined.

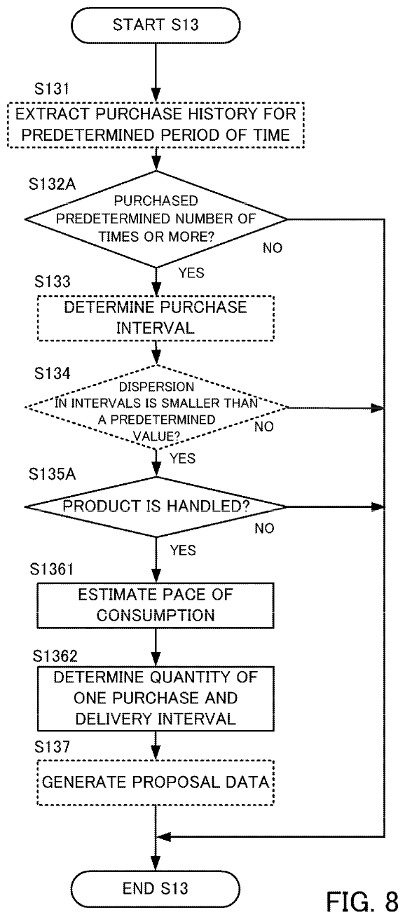

FIG. 8 is a flowchart of a process that is performed by the server apparatus 100 in the second embodiment. Steps the same as those in the first embodiment are illustrated by dotted lines, and a description thereof is omitted.

In the second embodiment, in step S132A, the number of times a product is purchased in the past is determined using the group ID instead of the product ID. That is, the number of times products belonging to a same group are purchased is determined.

Furthermore, in step S135A, the EC server 300 is inquired of whether a product belonging to the same group is handled or not. Additionally, in the case where the EC server 300 handles a plurality of products belonging to the same group, information about each product (such as the net quantity or the number of contained pieces) is temporarily stored.

In step S1361, the pace of consumption is determined for the target product. For example, in the case where the target product is toilet paper of a specific brand, and a product including four rolls is purchased at an interval of one month, it can be determined that “one roll is consumed in a week”. In the present step, the number of days taken to consume a set minimum unit of the product is determined.

In step S1362, optimum purchase quantity and delivery interval are determined based on the pace of consumption that is determined. Specifically, the pace of consumption that is determined is applied to each product (acquired in step S135A) for which periodic purchase is possible, and a determination is made as to which product (which package) is to be delivered at what interval. For example, in the case where one roll of toilet paper is consumed in a week, a plurality of order patterns such as “deliver a product with four rolls every month” and “deliver a product with 12 rolls once every three months” may be determined.

Additionally, in the present step, a best-before date or a use-by date of the product may be taken into account. For example, in the case where the target product is a product with a time limit, such as food or medicine, a large-quantity package is possibly not consumed within the time limit even if purchased. To cope with such a situation, whether a product can be consumed by the best-before date or the use-by date may be determined based on the pace of consumption, and an order pattern that is not recommended may be excluded.

Additionally, in the case where there is a plurality of order patterns, a pattern to be adopted may be determined according to a predetermined rule. For example, a pattern according to which the unit price of the product is the cheapest may be adopted. Furthermore, options as to which pattern should be adopted may be included in the proposal data to inquire of the user.

According to the second embodiment, a proposal regarding the purchase quantity and the delivery interval may be appropriately made by estimating the pace of consumption of the product.

### Modification of Second Embodiment

In the embodiment described above, the proposal data is generated by performing the processes illustrated in FIG. 4 every predetermined period of time. However, if a proposal is made in a state where there is a sufficient quantity of product in possession of the user, such a proposal is not likely to be accepted. Accordingly, a stock quantity of product in possession of the user may be estimated, and a proposal may be made at a timing when the stock quantity becomes low.

In the second embodiment, the pace of consumption of the product by the user, and a date of last purchase of the product may be acquired. Accordingly, by calculating the pace of consumption based on the date, a timing when the stock quantity of the product in possession of the user falls to or below a predetermined value may be specified. By suspending execution of step S14 until the timing arrives, a proposal may be made to the user at an appropriate timing.

Instead of suspending execution of step S14, a first delivery date by periodic purchase may be determined based on the stock quantity. For example, a proposal may be made in the manner of “According to the current pace of consumption, the stock quantity will fall below a predetermined value by the end of the month. Apply for periodic purchase such that a first product will arrive at the end of the month.”

(Modification)

The embodiments described above are merely examples, and the present disclosure may be changed and implemented as appropriate within the scope of the disclosure.

For example, processes and units described in the present disclosure may be freely combined and implemented to the extent that no technical conflict exists.

Furthermore, in the description of the embodiments, a single EC server 300 is illustrated, but a plurality of EC servers 300 operated by different operators may be included in the system. In this case, the history acquisition unit 1011 of the server apparatus 100 may log into the plurality of EC servers 300 and perform the illustrated processes. Furthermore, an EC server that provides the purchase history data and an EC server that provides the periodic purchase service may be different servers. Moreover, a first EC server that provides the purchase history data and a second EC server that provides the periodic purchase service may be operated by different operators.

Furthermore, in the description of the embodiments, the history acquisition unit 1011 acquires the purchase history data from the EC server, but the purchase history data may be data indicating a purchase history of products at a physical store. In this case, the server apparatus 100 may acquire, as the purchase history data, data about cashless payment performed by the user.

Furthermore, a process that is described to be performed by one apparatus may be shared and performed by a plurality of apparatuses. Processes described to be performed by different apparatuses may be performed by one apparatus. Which function is to be implemented by which hardware configuration (server configuration) in a computer system may be flexibly changed.

The present disclosure may also be implemented by supplying computer programs for implementing the functions described in the embodiments described above to a computer, and by one or more processors of the computer reading out and executing the programs. Such computer programs may be provided to the computer by a non-transitory computer-readable storage medium that can be connected to a system bus of the computer, or may be provided to the computer via a network. The non-transitory computer-readable storage medium may be any type of disk including magnetic disks (floppy (registered trademark) disks, hard disk drives (HDDs), etc.) and optical disks (CD-ROMs, DVD discs, Blu-ray discs, etc.), read-only memories (ROMs), random access memories (RAMs), EPROMs, EEPROMs, magnetic cards, flash memories, optical cards, and any type of medium suitable for storing electronic instructions.

What is claimed is:

1. An information processing apparatus comprising a controller configured to
acquire a purchase history of products purchased by a user in a past,
make a determination, based on the purchase history, that there is a target product that is purchased by the user on a regular basis, and
make a proposal to the user, based on a result of the determination, to purchase the target product using a periodic purchase service.

2. The information processing apparatus according to claim 1, wherein
the controller makes the proposal in a case where the target product is purchased a predetermined number of times or more by the user in a predetermined period of time in the past.

3. The information processing apparatus according to claim 1, wherein
the controller
acquires a reply of the user to the proposal, and
transmits, based on the reply, data for applying for use of the periodic purchase service, to a server apparatus that provides the periodic purchase service.

4. The information processing apparatus according to claim 1, wherein
the controller inquires of a server apparatus that provides the periodic purchase service whether the target product is handled or not, and makes the proposal in a case where the target product is handled by the periodic purchase service.

5. The information processing apparatus according to claim 1, wherein
the controller
determines a purchase interval of the target product in a predetermined period of time in the past, based on the purchase history, and
proposes a delivery interval for the periodic purchase service, based on the purchase interval.

6. The information processing apparatus according to claim 5, wherein
the controller makes the proposal in a case where dispersion in the purchase interval is smaller than a predetermined value.

7. The information processing apparatus according to claim 1, wherein
the target product includes a plurality of variations of products that are different from each other only in terms of net quantity.

8. The information processing apparatus according to claim 7, wherein
the controller acquires a purchase interval of the target product in a predetermined period of time in the past and information indicating the net quantity of a package of the target product, and estimates a pace of consumption of the target product.

9. The information processing apparatus according to claim 8, wherein
the controller makes a proposal regarding a delivery interval and an order quantity for the periodic purchase service, based on the pace of consumption that is estimated.

10. The information processing apparatus according to claim 8, wherein
the controller
estimates a stock quantity of the target product in possession of the user, based on the pace of consumption that is estimated, and
makes the proposal at a timing when the stock quantity falls below a predetermined value.

11. An information processing method comprising:
acquiring a purchase history of products purchased by a user in a past;
making a determination, based on the purchase history, that there is a target product that is purchased by the user on a regular basis; and
making a proposal to the user, based on a result of the determination, to purchase the target product using a periodic purchase service.

12. The information processing method according to claim 11, wherein
the proposal is made in a case where the target product is purchased a predetermined number of times or more by the user in a predetermined period of time in the past.

13. The information processing method according to claim 11, wherein
a reply of the user to the proposal is acquired, and
data for applying for use of the periodic purchase service is transmitted, based on the reply, to a server apparatus that provides the periodic purchase service.

14. The information processing method according to claim 11, wherein
a server apparatus that provides the periodic purchase service is inquired of whether the target product is handled or not, and the proposal is made in a case where the target product is handled by the periodic purchase service.

15. The information processing method according to claim 11, wherein
a purchase interval of the target product in a predetermined period of time in the past is determined based on the purchase history, and
a delivery interval for the periodic purchase service is proposed based on the purchase interval.

16. The information processing method according to claim 15, wherein
the proposal is made in a case where dispersion in the purchase interval is smaller than a predetermined value.

17. The information processing method according to claim 11, wherein
the target product includes a plurality of variations of products that are different from each other only in terms of net quantity.

18. The information processing method according to claim 17, wherein
a purchase interval of the target product in a predetermined period of time in the past and information indicating the net quantity of a package of the target product are acquired, and a pace of consumption of the target product is estimated.

19. The information processing method according to claim 18, wherein
a proposal regarding a delivery interval and an order quantity for the periodic purchase service is made based on the pace of consumption that is estimated.

20. A non-transitory computer readable storing medium recording a computer program for causing a computer to perform the information processing method according to claim 11.
